(19) United States
(12) Patent Application Publication
(10) Pub. No.: US 2009/0325851 A1
(43) Pub. Date: Dec. 31, 2009

(54) Neutralisation Process for Producing a Laundry Detergent Composition Comprising Anionic Detersive Surfactant and Polymeric Material

(76) Inventor: Tantawy Hossam Hassan, Northumberland (GB)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/486,773

(22) Filed: Jun. 18, 2009

(30) Foreign Application Priority Data
Jun. 25, 2008 (EP) 08158991.3

(51) Int. Cl. C11D 3/37

(52) U.S. Cl. 510/361

(57) ABSTRACT

The present invention relates to a process for preparing a laundry detergent composition comprising the steps of: (a) contacting an acid surfactant precursor with a polymeric material to form an mixture; and (b) contacting the mixture with an alkalinity source to form a composition comprising anionic detersive surfactant and polymeric material.

### FIELD OF THE INVENTION

The present invention relates to a process for preparing a laundry detergent composition.

### BACKGROUND OF THE INVENTION

Laundry detergent compositions typically comprise anionic detersive surfactants. Methods of incorporating anionic detersive surfactants into laundry detergent compositions include the in-situ neutralization of an acid anionic surfactant precursor with an alkalinity source such as carbonate, sodium hydroxide and/or silicate. However, there is a need to improve the solubility profile of the laundry detergent products produced by these in-situ neutralization processes, especially at cold washing temperatures, such as 30° C. or less.

The Inventors have found that contacting the acid anionic detersive surfactant precursor with a polymeric material prior to the neutralization step, results in a laundry detergent composition having an improved solubility profile. In addition, the Inventors have found that the cleaning performance of these laundry detergent products is also significantly improved.

### SUMMARY OF THE INVENTION

The present invention relates to a process as defined in claim 1.

### DETAILED DESCRIPTION OF THE INVENTION

### Process for Preparing a Laundry Detergent Composition

The process comprising the steps of: (a) contacting an acid surfactant precursor with a polymeric material to form a mixture; and (b) contacting the mixture with an alkalinity source to form a composition comprising anionic detersive surfactant and polymeric material.

Preferably, step (a) is carried out in an environment that comprises less than 15%, by weight of the resultant mixture, of water. Step (a) is typically carried out in a moderate or high shear mixer.

### Laundry Detergent Composition

The laundry detergent composition typically comprises: (a) anionic detersive surfactant; (b) from 0 wt % to 10 wt % zeolite builder; (c) from 0 wt % to 10 wt % phosphate builder; and (d) optionally from 0 wt % to 20 wt % silicate salt. The laundry detergent composition is typically in solid form.

The composition can be in any suitable form, such as free-flowing powder, tablet, unit dose form pouch form, typically being enclosed by a water-soluble film, such as polyvinyl alcohol. The composition may be in the form of a gel, or even liquid. Typically, the composition is in solid form. Typically, the laundry detergent composition comprises one or more adjunct detergent ingredients.

### Anionic Detersive Surfactant

The anionic detersive surfactant preferably comprises alkyl benzene sulphonate. The anionic detersive surfactant preferably comprises at least 50%, preferably at least 55%, or at least 60%, or at least 65%, or at least 70%, or even at least 75%, by weight of the anionic detersive surfactant, of alkyl benzene sulphonate. The alkyl benzene sulphonate preferably is a linear or branched, substituted or unsubstituted, C₈₋₁₈ alkyl benzene sulphonate. This is the optimal level of the C₈₋₁₈ alkyl benzene sulphonate to provide a good cleaning performance. The C₈₋₁₈ alkyl benzene sulphonate can be a modified alkylbenzene sulphonate (MLAS) as described in more detail in WO 99/05243, WO 99/05242, WO 99/05244, WO 99/05082, WO 99/05084, WO 99/05241, WO 99/07656, WO 00/23549, and WO 00/23548. Highly preferred C₈₋₁₈ alkyl benzene sulphonates are linear C₁₀₋₁₃ alkylbenzene sulphonates. Especially preferred are linear C₁₀₋₁₃ alkylbenzene sulphonates that are obtainable, preferably obtained, by sulphonating commercially available linear alkyl benzenes (LAB); suitable LAB include low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®.

The anionic detersive surfactant may preferably comprise other anionic detersive surfactants. A preferred adjunct anionic detersive surfactant is a non-alkoxylated anionic detersive surfactant. The non-alkoxylated anionic detersive surfactant can be an alkyl sulphate, an alkyl phosphate, an alkyl phosphonate, an alkyl carboxylate or any mixture thereof. The non-alkoxylated anionic surfactant can be selected from the group consisting of; C₁₀-C₂₀ primary, branched-chain, linear-chain and random-chain alkyl sulphates (AS), typically having the following formula:

CH₃(CH₂)ₓCH₂—OSO₃⁻M⁺

wherein, M is hydrogen or a cation which provides charge neutrality, preferred cations are sodium and ammonium cations, wherein x is an integer of at least 7, preferably at least 9; C₁₀-C₁₈ secondary (2,3) alkyl sulphates, typically having the following formulae:

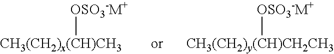

wherein, M is hydrogen or a cation which provides charge neutrality, preferred cations include sodium and ammonium cations, wherein x is an integer of at least 7, preferably at least 9, y is an integer of at least 8, preferably at least 9; C₁₀-C₁₈ alkyl carboxylates; mid-chain branched alkyl sulphates as described in more detail in U.S. Pat. No. 6,020,303 and U.S. Pat. No. 6,060,443; methyl ester sulphonate (MES); alpha-olefin sulphonate (AOS); and mixtures thereof.

Another preferred anionic detersive surfactant is an alkoxylated anionic detersive surfactant. The presence of an alkoxylated anionic detersive surfactant in the spray-dried powder provides good greasy soil cleaning performance, gives a good sudsing profile, and improves the hardness tolerance of the anionic detersive surfactant system. It may be preferred for the anionic detersive surfactant to comprise from 1% to 50%, or from 5%, or from 10%, or from 15%, or from 20%, and to 45%, or to 40%, or to 35%, or to 30%, by weight of the anionic detersive surfactant system, of an alkoxylated anionic detersive surfactant.

Preferably, the alkoxylated anionic detersive surfactant is a linear or branched, substituted or unsubstituted C₁₂₋₁₈ alkyl alkoxylated sulphate having an average degree of alkoxylation of from 1 to 30, preferably from 1 to 10. Preferably, the alkoxylated anionic detersive surfactant is a linear or branched, substituted or unsubstituted C₁₂₋₁₈ alkyl ethoxylated sulphate having an average degree of ethoxylation of from 1 to 10. Most preferably, the alkoxylated anionic detersive surfactant is a linear unsubstituted C₁₂₋₁₈ alkyl ethoxylated sulphate having an average degree of ethoxylation of from 3 to 7.

The alkoxylated anionic detersive surfactant, when present with an alkyl benzene sulphonate may also increase the activity of the alkyl benzene sulphonate by making the alkyl benzene sulphonate less likely to precipitate out of solution in the presence of free calcium cations. Preferably, the weight ratio of the alkyl benzene sulphonate to the alkoxylated anionic detersive surfactant is in the range of from 1:1 to less than 5:1, or to less than 3:1, or to less than 1.7:1, or even less than 1.5:1. This ratio gives optimal whiteness maintenance performance combined with a good hardness tolerance profile and a good sudsing profile. However, it may be preferred that the weight ratio of the alkyl benzene sulphonate to the alkoxylated anionic detersive surfactant is greater than 5:1, or greater than 6:1, or greater than 7:1, or even greater than 10:1. This ratio gives optimal greasy soil cleaning performance combined with a good hardness tolerance profile, and a good sudsing profile.

Suitable alkoxylated anionic detersive surfactants are: Texapan LEST™ by Cognis; Cosmacol AES™ by Sasol; BES151™ by Stephan; Empicol ESC70/U™; and mixtures thereof.

Preferably, the anionic detersive surfactant comprises from 0% to 10%, preferably to 8%, or to 6%, or to 4%, or to 2%, or even to 1%, by weight of the anionic detersive surfactant, of unsaturated anionic detersive surfactants such as alpha-olefin sulphonate. Preferably the anionic detersive surfactant is essentially free of unsaturated anionic detersive surfactants such as alpha-olefin sulphonate. By “essentially free of” it is typically meant “comprises no deliberately added”. Without wishing to be bound by theory, it is believed that these levels of unsaturated anionic detersive surfactants such as alpha-olefin sulphonate ensure that the anionic detersive surfactant is bleach compatible.

Preferably, the anionic detersive surfactant comprises from 0% to 10%, preferably to 8%, or to 6%, or to 4%, or to 2%, or even to 1%, by weight of alkyl sulphate. Preferably the anionic detersive surfactant is essentially free of alkyl sulphate. Without wishing to be bound by theory, it is believed that these levels of alkyl sulphate ensure that the anionic detersive surfactant is hardness tolerant.

At least part of the anionic detersive surfactant is in the form of a spray-dried powder. However, some of the anionic detersive surfactant may in non-spray-dried form, such as in the form of an agglomerate. Alternatively, essentially all of the anionic detersive surfactant is in spray-dried form.

### Acid Anionic Surfactant Precursor

The acid anionic surfactant precursor can be any acidic precursor, preferably a sulphonic acid, preferably an alkylaryl sulphonic acid. Preferably the acid anionic surfactant precursor comprises C₈-C₂₄ alkyl benzene sulphonic acid.

### Polymeric Material

The polymeric material is preferably comprises a random graft co-polymer, and/or a carboxylate polymer. The polymeric material is preferably hydrophobically modified.

### Random Graft Co-Polymer

The random graft co-polymer typically comprises: (i) hydrophilic backbone comprising monomers selected from the group consisting of: unsaturated C₁-C₆ carboxylic acids, ethers, alcohols, aldehydes, ketones, esters, sugar units, alkoxy units, maleic anhydride, saturated polyalcohols such as glycerol, and mixtures thereof; and (ii) hydrophobic side chain(s) selected from the group consisting of: C₄-C₂₅ alkyl group, polypropylene, polybutylene, vinyl ester of a saturated C₁-C₆ mono-carboxylic acid, C₁-C₆ alkyl ester of acrylic or methacrylic acid, and mixtures thereof.

The polymer preferably has the general formula:

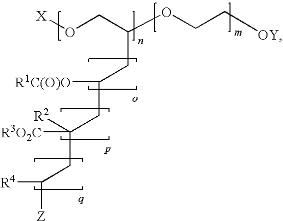

wherein X, Y and Z are capping units independently selected from H or a C₁₋₆ alkyl; each R¹ is independently selected from methyl and ethyl; each R² is independently selected from H and methyl; each R³ is independently a C₁₋₄ alkyl; and each R⁴ is independently selected from pyrrolidone and phenyl groups. The weight average molecular weight of the polyethylene oxide backbone is typically from about 1,000 g/mol to about 18,000 g/mol, or from about 3,000 g/mol to about 13,500 g/mol, or from about 4,000 g/mol to about 9,000 g/mol. The value of m, n, o, p and q is selected such that the pendant groups comprise, by weight of the polymer at least 50%, or from about 50% to about 98%, or from about 55% to about 95%, or from about 60% to about 90%. The polymer useful herein typically has a weight average molecular weight of from about 1,000 to about 100,000 g/mol, or preferably from about 2,500 g/mol to about 45,000 g/mol, or from about 7,500 g/mol to about 33,800 g/mol, or from about 10,000 g/mol to about 22,500 g/mol.

Suitable graft co-polymers are described in more detail in WO07/138054, WO06/108856 and WO06/113314.

### Carboxylate Polymer

Preferred polymeric polycarboxylates include: polyacrylates, preferably having a weight average molecular weight of from 1,000 Da to 20,000 Da; co-polymers of maleic acid and acrylic acid, preferably having a molar ratio of maleic acid monomers to acrylic acid monomers of from 1:1 to 1:10 and a weight average molecular weight of from 10,000 Da to 200,000 Da, or preferably having a molar ratio of maleic acid monomers to acrylic acid monomers of from 0.3:1 to 3:1 and a weight average molecular weight of from 1,000 Da to 50,000 Da.

### Alkalinity Source

The alkalinity source preferably comprises carbonate salt such as sodium carbonate, sodium hydroxide and/or silicate salt such as sodium silicate.

### Zeolite Builder

The composition typically comprises from 0% to 10 wt % zeolite builder, preferably to 9 wt %, or to 8 wt %, or to 7 wt %, or to 6 wt %, or to 5 wt %, or to 4 wt %, or to 3 wt %, or to 2 wt %, or to 1 wt %, or to less than 1% by weight of the composition, of zeolite builder. It may even be preferred for the composition to be essentially free from zeolite builder. By essentially free from zeolite builder it is typically meant that the composition comprises no deliberately added zeolite builder. This is especially preferred if it is desirable for the composition to be very highly soluble, to minimise the amount of water-insoluble residues (for example, which may deposit on fabric surfaces), and also when it is highly desirable to have transparent wash liquor. Zeolite builders include zeolite A, zeolite X, zeolite P and zeolite MAP.

### Phosphate Builder

The composition typically comprises from 0% to 10 wt % phosphate builder, preferably to 9 wt %, or to 8 wt %, or to 7 wt %, or to 6 wt %, or to 5 wt %, or to 4 wt %, or to 3 wt %, or to 2 wt %, or to 1 wt %, or to less than 1% by weight of the composition, of phosphate builder. It may even be preferred for the composition to be essentially free from phosphate builder. By essentially free from phosphate builder it is typically meant that the composition comprises no deliberately added phosphate builder. This is especially preferred if it is desirable for the composition to have a very good environmental profile. Phosphate builders include sodium tripolyphosphate.

### Adjunct Detergent Ingredients

Suitable adjunct ingredients include: detersive surfactants such as anionic detersive surfactants, nonionic detersive surfactants, cationic detersive surfactants, zwitterionic detersive surfactants, amphoteric detersive surfactants; preferred nonionic detersive surfactants are C₈₋₁₈ alkyl alkoxylated alcohols having an average degree of alkoxylation of from 1 to 20, preferably from 3 to 10, most preferred are C₁₂₋₁₈ alkyl ethoxylated alcohols having an average degree of alkoxylation of from 3 to 10; preferred cationic detersive surfactants are mono-C₆₋₁₈ alkyl mono-hydroxyethyl di-methyl quaternary ammonium chlorides, more preferred are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride; source of peroxygen such as percarbonate salts and/or perborate salts, preferred is sodium percarbonate, the source of peroxygen is preferably at least partially coated, preferably completely coated, by a coating ingredient such as a carbonate salt, a sulphate salt, a silicate salt, borosilicate, or mixtures, including mixed salts, thereof; bleach activator such as tetraacetyl ethylene diamine, oxybenzene sulphonate bleach activators such as nonanoyl oxybenzene sulphonate, caprolactam bleach activators, imide bleach activators such as N-nonanoyl-N-methyl acetamide, preformed peracids such as N,N-pthaloylamino peroxycaproic acid, nonylamido peroxyadipic acid or dibenzoyl peroxide; enzymes such as amylases, carbohydrases, cellulases, laccases, lipases, oxidases, peroxidases, proteases, pectate lyases and mannanases; suds suppressing systems such as silicone based suds suppressors; fluorescent whitening agents; photobleach; filler salts such as sulphate salts, preferably sodium sulphate; fabric-softening agents such as clay, silicone and/or quaternary ammonium compounds; flocculants such as polyethylene oxide; dye transfer inhibitors such as polyvinylpyrrolidone, poly 4-vinylpyridine N-oxide and/or co-polymer of vinylpyrrolidone and vinylimidazole; fabric integrity components such as hydrophobically modified cellulose and oligomers produced by the condensation of imidazole and epichlorhydrin; soil dispersants and soil anti-redeposition aids such as alkoxylated polyamines and ethoxylated ethyleneimine polymers; anti-redeposition components such as carboxymethyl cellulose and polyesters; perfumes; sulphamic acid or salts thereof; citric acid or salts thereof; and dyes such as orange dye, blue dye, green dye, purple dye, pink dye, or any mixture thereof.

Preferably, the composition comprises less than 1 wt % chlorine bleach and less than 1 wt % bromine bleach. Preferably, the composition is essentially free from bromine bleach and chlorine bleach. By “essentially free from” it is typically meant “comprises no deliberately added”.

### EXAMPLES

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### Example 1

### An Anionic Detersive Surfactant Particle and Process of Making it

15 parts of C₈-C₂₄ alkyl benzene sulphonic acid (HLAS) and 2 parts of random graft co-polymer are mixed together to form a mixture in a tank. This mixture is pressure sprayed into a Forberg mixer containing 83 parts of light anhydrous sodium carbonate, the components are mixed together, the HLAS is neutralized to form the sodium C₈-C₂₄ alkyl benzene sulphonate and an anionic detersive surfactant particle is formed.

¹random graft copolymer is a polyvinyl acetate grafted polyethylene oxide copolymer having a polyethylene oxide backbone and multiple polyvinyl acetate side chains. The molecular weight of the polyethylene oxide backbone is about 6000 and the weight ratio of the polyethylene oxide to polyvinyl acetate is about 40 to 60 and no more than 1 grafting point per 50 ethylene oxide units.

### Example 2

### An Anionic Detersive Surfactant Particle and Process of Making it

A process of example 1 is followed except that a co-polymer of maleic/acrylic acid is used instead of the random graft co-polymer.

### Example 3

### An Anionic Detersive Surfactant Particle and Process of Making it

A process of example 1 is followed except that 73 parts of light anhydrous sodium carbonate and 10 parts of 1.6R sodium silicate are contained in the Forberg mixer instead of 83 parts of light anhydrous sodium carbonate.

### Example 4

### An Anionic Detersive Surfactant Particle and Process of Making it

15 parts of C₈-C₂₄ alkyl benzene sulphonic acid (HLAS) and 2 parts of random graft co-polymer are mixed together to form a mixture in a tank. 1.3 parts of 50% w/w aqueous solution of sodium hydroxide is added to the tank and the components are mixed to partial neutralise the HLAS. This partially neutralized mixture is pressure sprayed into a Forberg mixer containing 81.7 parts of light anhydrous sodium carbonate, the components are mixed together, the HLAS is fully neutralized to form the sodium C₈-C₂₄ alkyl benzene sulphonate and an anionic detersive surfactant particle is formed.

### Example 5

### A Granular Laundry Detergent Composition

| | % w/w granular |
|---|---|
| | laundry |
| Component | detergent composition |
| Any particle of example 1, 2, 3, 4 or any | 59.38 |
| mixture thereof | |
| 91.6 wt % active linear alkyl benzene sulphonate | 0.22 |
| flake supplied by Stepan under the | |
| tradename Nacconol 90G ® | |
| Citric acid | 5.00 |
| Sodium percarbonate (having from 12% to 15% | 14.70 |
| active AvOx) | |
| Photobleach particle | 0.01 |
| Lipase (11.00 mg active/g) | 0.70 |
| Amylase (21.55 mg active/g) | 0.33 |
| Protease (56.00 mg active/g) | 0.43 |
| Tetraacetyl ethylene diamine agglomerate | 4.35 |
| (92 wt % active) | |
| Suds suppressor agglomerate (11.5 wt % active) | 0.87 |
| Acrylate/maleate copolymer particle | 0.29 |
| (95.7 wt % active) | |
| Green/Blue carbonate speckle | 0.50 |
| Sodium Sulphate | 12.59 |
| Solid perfume particle | 0.63 |
| Total Parts | 100.00 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for preparing a laundry detergent composition comprising the steps of:
(a) contacting an acid surfactant precursor with a polymeric material to form an mixture; and
(b) contacting the mixture with an alkalinity source to form a composition comprising anionic detersive surfactant and polymeric material.

2. A process according to claim 1, wherein the acid surfactant precursor comprises C₈-C₂₄ alkyl benzene sulphonic acid.

3. A process according to any claim 1, wherein the polymeric material comprises a random graft co-polymer, wherein the random graft co-polymer comprises:
(i) hydrophilic backbone comprising monomers selected from the group consisting of: unsaturated C₁-C₆ carboxylic acids, ethers, alcohols, aldehydes, ketones, esters, sugar units, alkoxy units, maleic anhydride, saturated polyalcohols such as glycerol, and mixtures thereof; and
(ii) hydrophobic side chain(s) selected from the group consisting of: C₄-C₂₅ alkyl group, polypropylene, polybutylene, vinyl ester of a saturated C₁-C₆ mono-carboxylic acid, C₁-C₆ alkyl ester of acrylic or methacrylic acid, and mixtures thereof.

4. A process according to claim 1, wherein the polymeric material comprises a carboxylate polymer.

5. A process according to claim 1, wherein the alkalinity source comprises carbonate salt.

6. A process according to claim 1, wherein the alkalinity source comprises sodium hydroxide.

7. A process according to claim 1, wherein the alkalinity source comprises silicate salt.

8. A process according to claim 1, wherein the laundry detergent composition comprises:
(a) anionic detersive surfactant;
(b) from 0 wt % to 10 wt % zeolite builder;
(c) from 0 wt % to 10 wt % phosphate builder; and
(d) optionally from 0 wt % to 20 wt % silicate salt.

9. A process according to claim 1, wherein the laundry detergent composition is in solid form.
